(19) United States
(12) Patent Application Publication
(10) Pub. No.: US 2025/0272631 A1
(43) Pub. Date: Aug. 28, 2025

(54) WORK SUPPORT SYSTEM, WORK SUPPORT METHOD, AND INFORMATION STORAGE MEDIUM

(71) Applicants: Cybozu, Inc., Tokyo (JP); Cybozu Labs, Inc., Tokyo (JP)

(72) Inventors: Kaoru NAKAJIMA, Tokyo (JP); Kota UCHIDA, Fujimino-shi (JP); Hideki IGARASHI, Yokohama-shi (JP); Hayato SHIMOJI, Ichinomiya-shi (JP); Ryosuke TSUKIOKA, Saijo-shi (JP)

(21) Appl. No.: 19/058,003

(22) Filed: Feb. 20, 2025

(30) Foreign Application Priority Data
Feb. 26, 2024 (JP) 2024-026498

(51) Int. Cl. G06Q 10/0631

(52) U.S. Cl. CPC G06Q 10/063114

(57) ABSTRACT

Provided is a work support system including at least one processor configured to: acquire posted data indicating a post in a work support system; determine, based on the posted data, whether a group mention with respect to a group has been made; and issue, when it is determined that the group mention has been made, a group notification to a group user belonging to the group, the group notification being distinguished from a personal notification of a personal mention with respect to a person.

### CROSS-REFERENCE TO RELATED APPLICATION

The present disclosure contains subject matter related to that disclosed in Japanese Patent Application JP 2024-026498 filed in the Japan Patent Office on Feb. 26, 2024, the entire contents of which are hereby incorporated by reference.

### BACKGROUND OF THE INVENTION

### 1. Field of the Invention

The present disclosure relates to a work support system, a work support method, and an information storage medium.

### 2. Description of the Related Art

Hitherto, there has been known a “mention function” in which a user designates a specific party and makes a post. For example, in Japanese Patent Application Laid-open No. 2023-047417, there is described a chat service in which, in a chat having a mention function, when a user designates another user who is to be mentioned and posts a message, the chat service notifies the another user. The user can also use such a chat service to contact the another user about a business matter.

However, in the technology of Japanese Patent Application Laid-open No. 2023-047417, the user is required to designate a person as the party to be mentioned, and is not able to designate a group (for example, a team or a project) as the party to be mentioned. The user can notify all users by, for example, individually designating all other users belonging to a group as a party to be mentioned. However, the other users are not able to distinguish whether the notification is to themselves personally or to the group. For that reason, the technology of Japanese Patent Application Laid-open No. 2023-047417 has not been able to sufficiently increase convenience of the user.

### SUMMARY OF THE INVENTION

One object of the present disclosure is to increase convenience of a user.

According to at least one aspect of the present disclosure, there is provided a work support system including at least one processor configured to: acquire posted data indicating a post in a work support system; determine, based on the posted data, whether a group mention with respect to a group has been made; and issue, when it is determined that the group mention has been made, a group notification to a group user belonging to the group, the group notification being distinguished from a personal notification of a personal mention with respect to a person.

### BRIEF DESCRIPTION OF THE DRAWINGS

FIG. 1 is a diagram for illustrating an example of a hardware configuration of a work support system.

FIG. 2 is a view for illustrating an example of screens displayed on a user terminal.

FIG. 3 is a view for illustrating an example of screens displayed on the user terminal.

FIG. 4 is a view for illustrating an example of screens displayed on the user terminal.

FIG. 5 is a view for illustrating an example of screens displayed on the user terminal.

FIG. 6 is a diagram for illustrating an example of functions implemented in the work support system.

FIG. 7 is a table for showing an example of a user database.

FIG. 8 is a table for showing an example of a group database.

FIG. 9 is a table for showing an example of a post database.

FIG. 10 is a table for showing an example of a notification database.

FIG. 11 is a flowchart for illustrating an example of post processing.

FIG. 12 is a flowchart for illustrating an example of notification processing.

FIG. 13 is a diagram for illustrating an example of functions implemented in a work support system according to modification examples.

FIG. 14 is a view for illustrating an example of a group mention screen in Modification Example 2.

### DESCRIPTION OF THE EMBODIMENTS

### 1. Hardware Configuration

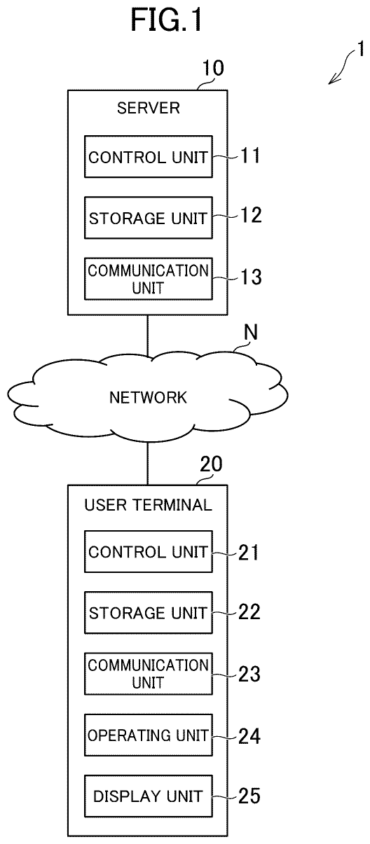

An example of a work support system, a work support method, and a program according to at least one embodiment of the present disclosure is described. FIG. 1 is a diagram for illustrating an example of a hardware configuration of the work support system. For example, a work support system 1 includes a server 10 and a user terminal 20. The server 10 and the user terminal 20 are each connected to a network N such as the Internet or a LAN. In FIG. 1, one server 10 and one user terminal 20 are illustrated, but a plurality of servers 10 may be present, and a plurality of user terminals 20 may be present.

The server 10 is a server computer. For example, the server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The user terminal 20 is a computer of a user. For example, the user terminal 20 is a personal computer, a tablet terminal, a smartphone, or a wearable terminal. For example, the user terminal 20 includes a control unit 21, a storage unit 22, a communication unit 23, an operating unit 24, and a display unit 25. Hardware configurations of the control unit 21, the storage unit 22, and the communication unit 23 may be the same as those of the control unit 11, the storage unit 12, and the communication unit 13, respectively. The operating unit 24 is an input device such as a mouse or a touch panel. The display unit 25 is a liquid crystal display or an organic EL display.

Programs stored in the storage units 12 and 22 may be supplied via the network N. A hardware configuration of each of the server 10 and the user terminal 20 is not limited to the example of FIG. 1. For example, at least one of the server 10 or the user terminal 20 may include at least one of a reading unit (for example, a memory card slot) that reads a computer-readable information storage medium or an input/output unit (for example, a USB terminal) for directly connecting to an external device. A program stored in the information storage medium may be supplied to at least one of the server 10 or the user terminal 20 through at least one of the reading unit or the input/output unit.

Moreover, the work support system 1 is only required to include at least one computer. The computers included in the work support system 1 are not limited to the example of FIG. 1. For example, the work support system 1 may include only the server 10. In this case, the user terminal 20 is present outside the work support system 1. The work support system 1 may include the server 10 and another server computer.

### 2. Overview of Work Support System

In the at least one embodiment, the work support system 1 has various functions that support work of users. For example, the work support system 1 may provide users with groupware of a cloud type or an on-premises type. The work support system 1 may provide users with a service that is not classified as groupware but supports work. For example, the user terminal 20 communicates to and from the server 10 and displays various screens in the work support system 1 on the display unit 25.

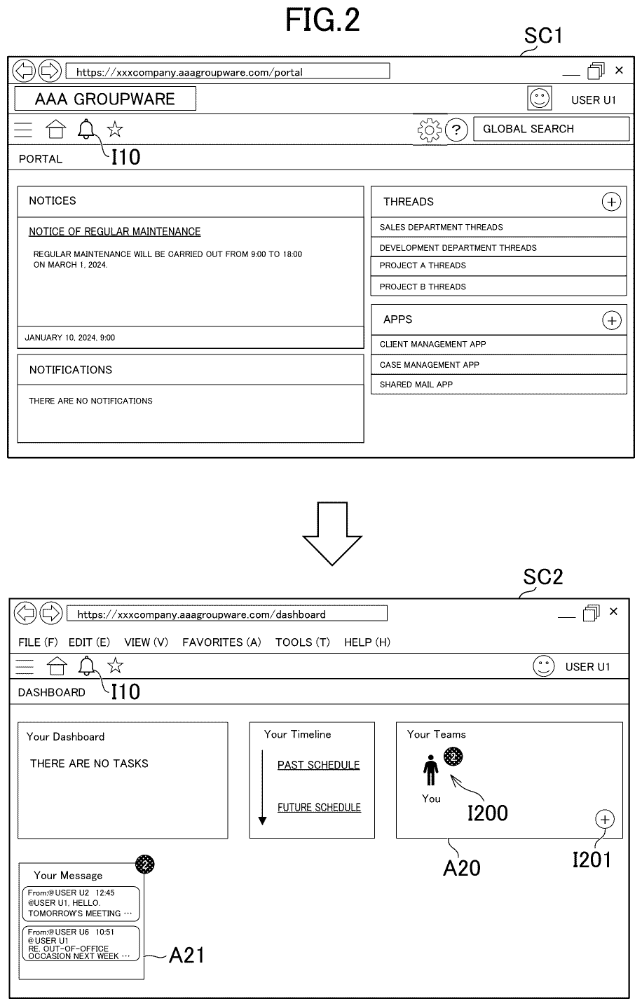

FIG. 2 to FIG. 5 are views for illustrating examples of screens displayed on the user terminal 20. For example, when a user logs in to the work support system 1, as in the upper half of FIG. 2, the user terminal 20 displays, on the display unit 25, a portal screen SC1 corresponding to the entrance to the work support system 1. The user can use the various functions that the work support system 1 has from the portal screen SC1. For example, from the portal screen SC1, the user may select a given thread and communicate with another user, or may register data relating to the work of the user in an application, which is a type of database.

In the at least one embodiment, among the functions that the work support system 1 has, a mention function is mainly described. The mention function is a function that allows a user who has made a post in the work support system 1 to mention a specific party. A post is the content of communication between users. A post can also be referred to as a “message” or a “comment.” In the at least one embodiment, a case in which a post to a thread, which is a type of bulletin board, is made is taken as an example. Posts may be made at any place in the work support system 1. For example, posts may be made in an app, a shared email, a schedule, a chat, a bulletin board not categorized as a thread, or some other place.

The term “mention” refers to the designation of a specific party as an addressee by the user. The user can mention any party. A user who has been mentioned is notified that a post has been made. For example, when a certain user is mentioned, the server 10 uses the notification function of the work support system 1 to notify the user. The notification may be made in any manner. For example, the server 10 may notify the user by email, a short message service (SMS), a push notification, a banner notification, a badge notification, a messaging app, a social networking service (SNS), or another method. A combination of those plurality of notification methods may be used.

For example, when the user selects an icon I10 on the portal screen SC1, as in the lower half of FIG. 2, the user terminal 20 displays, on the display unit 25, a dashboard screen SC2 for the user to check notifications. The dashboard screen SC2 is also one of the entrances to the work support system 1. When the user logs in to the work support system 1, the dashboard screen SC2 may be displayed first instead of the portal screen SC1. In the example in the lower half of FIG. 2, the dashboard screen SC2 displays not only notifications but also other information, such as a task or a timeline of the user.

For example, the dashboard screen SC2 includes a display area A20 for displaying the notifications received by the user. The display area A20 displays an icon I200 for displaying a personal notification that the user receives when a personal mention is made. A personal mention is a mention made with respect to a person. The personal mention may be made by using a publicly-known method. For example, the personal mention may be made by inputting a user name after a specific symbol such as “@.” The personal mention may be made by selecting an image such as a button instead of inputting a symbol or the like.

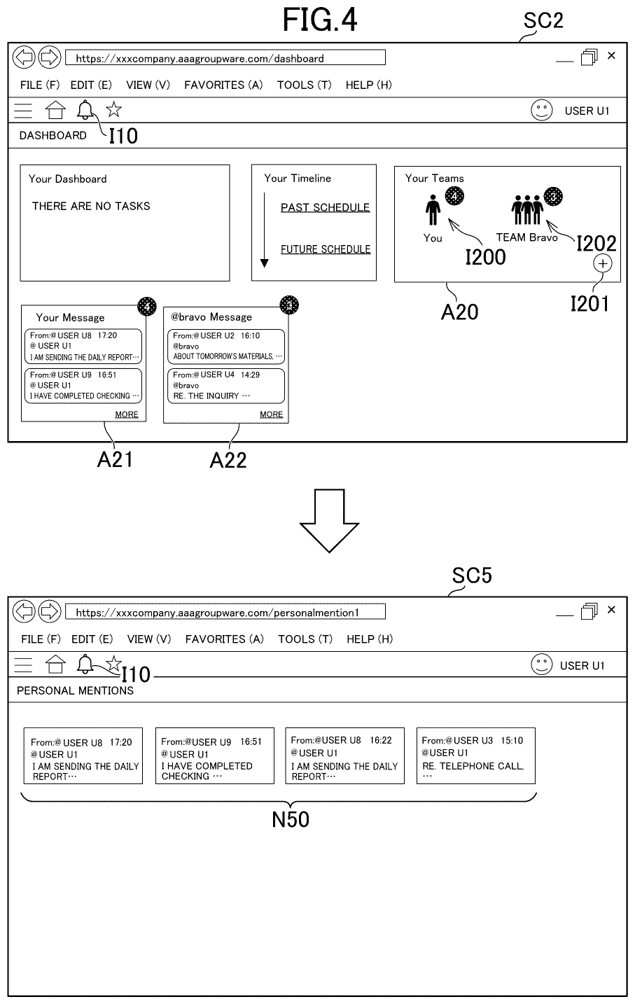

A personal notification is a notification issued to a person. Stated another way, a personal notification is a notification that the user receives when a personal mention is made. In the example in the lower half of FIG. 2, the dashboard screen SC2 includes a display area A21 in which at least some of the personal notifications are displayed. Among the personal notifications received by the user, the personal notifications that cannot fit in the display area A21 are displayed on a personal mention screen SC5 illustrated in the lower half of FIG. 4 described later. For example, when the user selects the icon I200, the user terminal 20 displays the personal mention screen SC5 described later on the display unit 25. The personal notification may be the same as a publicly-known notification.

In the at least one embodiment, the user can make not only a personal mention, but can also make a group mention with respect to a group. A group is a collection of at least one user. The group may be any unit. When the users of an organization such as a company use the work support system 1, the group may be the organization or a department within the organization. As another example, the group may be a team or a project. The group may be a gathering of users gathered for a social gathering, work colleagues who joined the company in the same year, club members, or users gathered for another purpose. The number of users belonging to the group may be any number. Users from the same organization may belong to the group, or users from different organizations may belong to the group.

In the at least one embodiment, a case in which the group mention is made in roughly the same way as the personal mention is taken as an example. For example, the group mention is made by inputting a group ID for identifying the group after a specific symbol such as “@.” Similarly to the personal mention, the group mention may be made by selecting an image such as a button instead of inputting a symbol or the like. The group mention may be made in a way completely different from that of the personal mention. The notification made when a group mention is made is hereinafter referred to as “group notification.” Further, when there is no particular distinction between a personal notification and a group notification, those terms are simply referred to as “notification.”

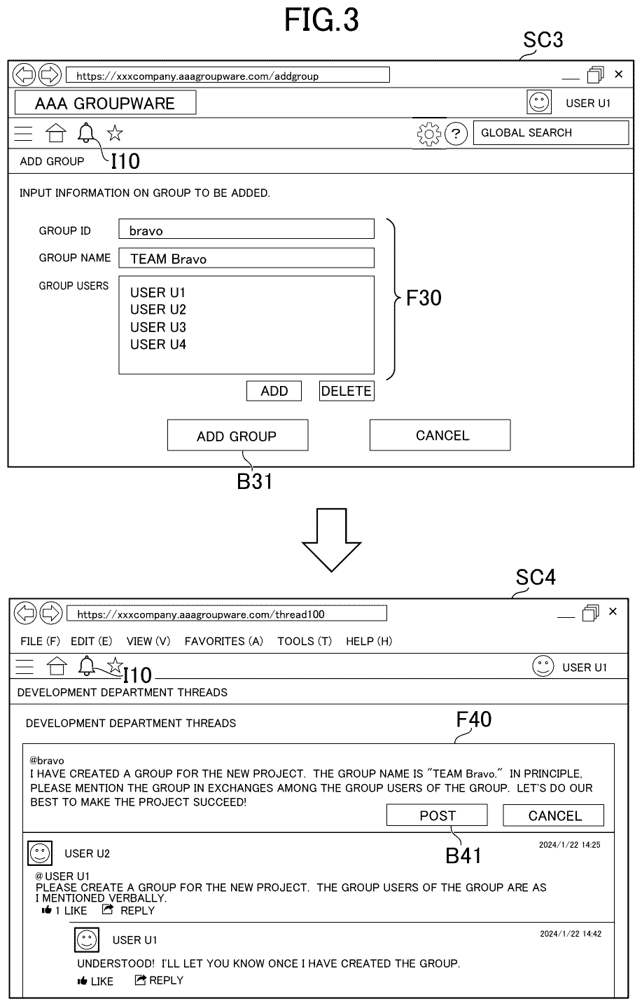

In the example in the lower half of FIG. 2, it is assumed that a group has not been created yet. The user performs an operation to add a new group. For example, as in the upper half of FIG. 3, when the user selects the icon I201, the user terminal 20 displays, on the display unit 25, an addition screen SC3 for adding a group. The user inputs a group ID, which is an ID for identifying the group, a group name, and the users belonging to the group into an input form F30. The user designates the group ID so that the group ID does not overlap with those of other groups. The group ID may be automatically generated. When the user inputs the required information into the input form F30 and selects a button B31, the server 10 adds a new group.

In the example in the upper half of FIG. 3, a group called “Team Bravo” to which four users U1 to U4 belong has been added. In the following description, when those four users are distinguished, one of the reference symbols U1 to U4 is used. When those four users are not distinguished, the associated reference symbol is not used. Further, a user belonging to the group is referred to as a “group user.” A user who does not belong to the group is referred to as an “external user.” When group users and external users are not distinguished, those users are simply referred to as “user.”

For example, when the group user U1 posts on the work support system 1, the group user U1 can make a group mention by designating the group ID. For example, when the group user U1 selects a thread for a new post, as in the lower half of FIG. 3, the user terminal 20 displays a thread screen SC4 showing the contents of the thread on the display unit 25. The group user U1 inputs a new post into an input form F40. Here, the group user U1 makes a group mention by inputting the character string “@bravo,” which means that the group mention is made with respect to the group “Team Bravo.”

For example, the group user U1 can input the body text of the post at any position before or after the character string “@bravo.” When the group user U1 inputs the post into the input form F40 and selects a button B41, the input of the post is completed. The server 10 can determine that the group user U1 has made a group mention based on the character string “@bravo” in the post made by the group user U1. When the server 10 determines that the group user U1 has made a group mention, the server 10 issues a group notification to the group users U2 to U4.

For example, the group users U2 to U4 receive the group notification indicating that a group mention has been made in the post by the group user U1. The group user U1, who is the person who has input the post, may also receive the group notification, but in the at least one embodiment, the person who has input the post does not receive the group notification. Each of the group users U1 to U4 communicates with each other by making group mentions as required. For example, each time one of the group users U1 to U4 designates the character string “@bravo” and makes a post, a group notification is issued.

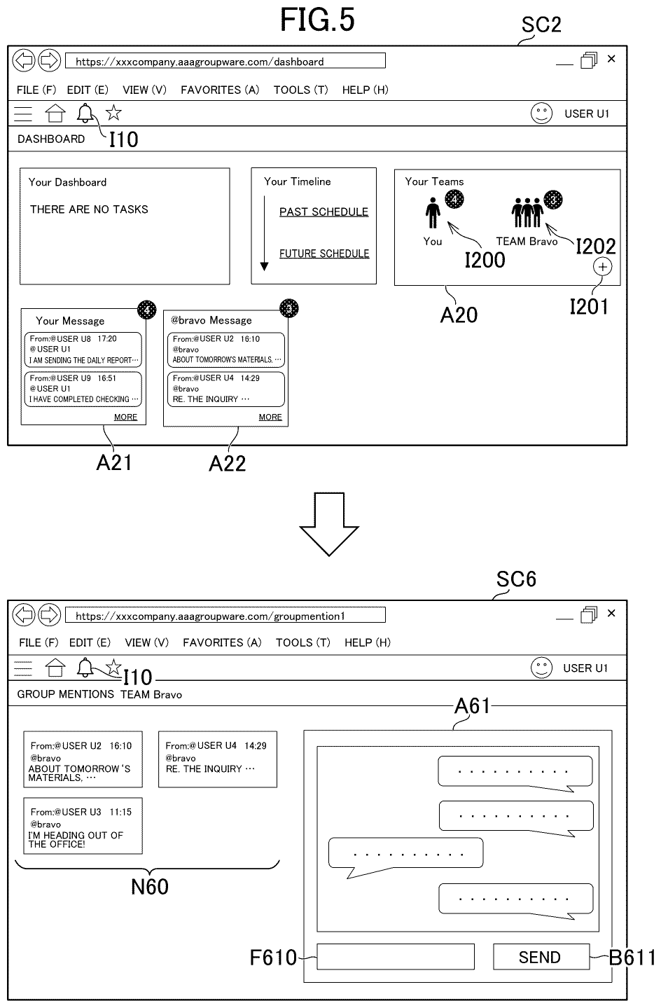

For example, when the group user U1 opens the dashboard screen SC2 after a certain number of group mentions have been made, as in the upper half of each of FIG. 4 and FIG. 5, the number of unread group notifications is displayed in a notification badge of an icon I202 of the group “Team Bravo.” The same icon I202 is also displayed on the dashboard screen SC2 of each of the group users U2 to U4. The notification badge of icon I202 indicates the number of group notifications unread by each of the group users U2 to U4. The number of unread group notifications may be linked to each other among the group users U1 to U4 in the group. For example, when the group user U2 views a certain group notification, the other group users U1, U3, and U4 may also view the group notification. For example, the group notification may be displayed such that, even when any one of the group users U1 to U4 views a certain group notification, the group notification is not marked as read unless all of the group users U1 to U4 have made a predetermined reaction (for example, a status change such as “replied” or “processed”). For example, the group notification may be displayed such that the group notification is not marked as read unless a specific person among the group users U1 to U4 has viewed the group notification.

For example, on the dashboard screen SC2 illustrated in the upper half of FIG. 4, when the group user U1 selects the icon I200, as in the lower half of FIG. 4, the user terminal 20 displays, on the display unit 25, a personal mention screen SC5 showing personal notifications N50 received by the group user U1. In the example in the lower half of FIG. 4, four personal notifications N50 are displayed on the personal mention screen SC5. When the group user U1 selects a personal notification N50, the user terminal 20 may display the details of the post indicated by the personal notification N50 on the display unit 25. For example, the details of the post may be displayed on the personal mention screen SC5, or may be displayed on a screen such as the thread screen SC4.

For example, on the dashboard screen SC2 illustrated in the upper half of FIG. 5, when the group user U1 selects the icon I202, as in the lower half of FIG. 5, the user terminal 20 displays, on the display unit 25, a group mention screen SC6 showing group notifications N60 received by the group user U1. In the example in the lower half of FIG. 5, three group notifications N60 are displayed on the group mention screen SC6. Further, as in the example in the lower half of FIG. 5, the group mention screen SC6 may include a display area A61 that shows in reverse chronological order posts in which a group mention has been made. In the example of the display area A61 of FIG. 5, posts in which a group mention has been made are displayed as speech bubble images.

The group mention screen SC6 may display only the group notifications N60 without displaying a speech bubble as in the example in the lower half of FIG. 5. For example, when the group user U1 selects a group notification N60, the user terminal 20 may display the details of the post indicated by the group notification N60 on the display unit 25. The details of the post may be displayed on a screen such as the thread screen SC4. As in the upper half of each of FIG. 4 and FIG. 5, the content corresponding to at least some of the group notifications N60 may be displayed in the display area A22 of the dashboard screen SC2.

As described above, the work support system 1 according to at least one embodiment displays the personal notifications N50 on the personal mention screen SC5, and displays the group notifications N60 on the group mention screen SC6. The personal mention screen SC5 and the group mention screen SC6 are separate screens, and hence each of the group users U1 to U4 can distinguish between the personal notifications N50 and the group notifications N60. In this way, the work support system 1 can increase convenience of each of the group users U1 to U4 by issuing the group notifications N60, which are distinguished from the personal notifications N50, to each of the group users U1 to U4. Details of the work support system 1 are described below.

### 3. Functions Implemented in Work Support System

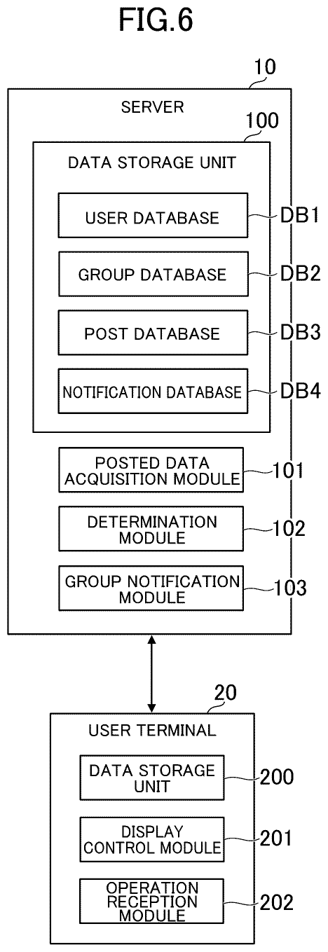

FIG. 6 is a diagram for illustrating an example of functions implemented in the work support system 1. In the at least one embodiment, among the functions of the work support system 1, the mention function for a group mention is mainly described.

### [3-1. Functions Implemented in Server]

For example, the server 10 includes a data storage unit 100, a posted data acquisition module 101, a determination module 102, and a group notification module 103. The data storage unit 100 is implemented by the storage unit 12. Each of the posted data acquisition module 101, the determination module 102, and the group notification module 103 is implemented by the control unit 11.

### [Data Storage Unit]

The data storage unit 100 stores data required for supporting work. For example, the data storage unit 100 stores a user database DB1 in which various kinds of data on users are stored, a group database DB2 in which group data indicating the groups created by the work support system 1 is stored, a post database DB3 in which various kinds of data on posts made in the work support system 1 are stored, and a notification database DB4 in which various kinds of data on notifications issued to users are stored.

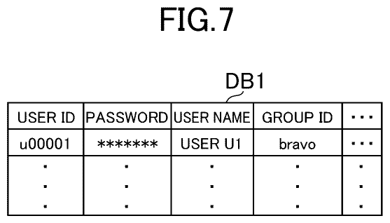

FIG. 7 is a table for showing an example of the user database DB1. For example, the user database DB1 stores data such as a user ID for identifying each user, a password, a user name, a group ID of the group to which the user belongs, and an organization to which the user belongs. The user database DB1 may store any data relating to the user. For example, the user database DB1 may store data indicating a work position, department, year of employment, years of service, or other information of a user.

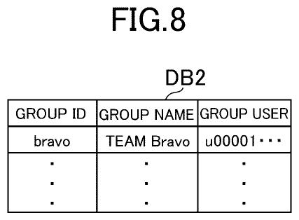

FIG. 8 is a table for showing an example of the group database DB2. For example, the group database DB2 stores group data on each of a plurality of groups. The group data indicates a group ID, a group name, and a user ID of each of the group users. When a user performs a group addition operation to add a new group to the work support system 1, the server 10 generates the group data of the group and stores the generated group data in the group database DB2. The group addition operation may be any operation. In the example of the addition screen SC3 of FIG. 3, input into the input form F30 and selection of the button B31 each correspond to a group addition operation.

Any data may be stored in the group database DB2. The data stored in the group database DB2 is not limited to the example of FIG. 8. For example, the group database DB2 may store the user ID of the user who has added the group, the organization to which the group was added, the date and time at which the group was added, various settings for the group, or other data.

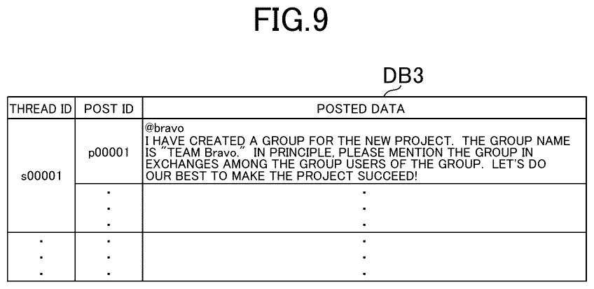

FIG. 9 is a table for showing an example of the post database DB3. In the at least one embodiment, a post to a thread is taken as an example, and hence the post database DB3 stores a thread ID, which is an ID for identifying a thread, a post ID, which is an ID for identifying a post, and posted data indicating a post to the thread. Any data may be stored in the post database DB3. The data stored in the post database DB3 is not limited to the example of FIG. 9. For example, the post database DB3 may store the user ID of the user who has made the post, the date and time of the post, information on the mentioned party, data on a reaction to the post, and the like.

For example, when the user creates a new thread, the server 10 issues a thread ID for the thread. When a new post is made to the thread, the posted data acquisition module 101 described later issues a post ID for the post. The posted data acquisition module 101 stores, in the post database DB3, the posted data indicating the new post in association with the thread ID and the post ID. The posted data may include not only text indicating content of the post, but also other data such as a file included in the post. The post database DB3 may store data on a notification made as a result of the post.

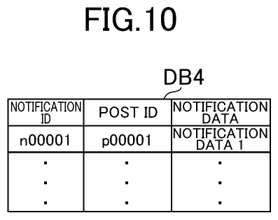

FIG. 10 is a table for showing an example of the notification database DB4. For example, the notification database DB4 stores a notification ID for identifying a notification, a post ID of the post which caused the notification, and notification data indicating the specific content of the notification. For example, when a new post is made and a new notification is required to be issued, the server 10 issues a notification ID for the new notification. The server 10 stores the notification ID, the post ID, and the notification data of the new notification in the notification database DB4 in association with each other.

The notification data indicates information required for a notification. For example, the notification data indicates a notification type, a notification destination, and information relating to display of the notification. The notification type indicates whether the notification is a personal notification N50 or a group notification N60. In the at least one embodiment, a case in which those two types of notifications are used is taken as an example, but there may be three or more types of notifications. For example, there may be a type indicating whether the notification is addressed to oneself or a notification addressed to someone other than oneself. In this case, the type may exist only for personal notifications, or may exist for group notifications as well.

The notification destination is the user ID of the users who have been personally mentioned, or the group ID of the mentioned group (or the user ID of the group users of the mentioned group). The specific content of the notification may be the character string of all or a part of the post, the user ID or user name of the poster who has made the post, the posting date and time, information on whether the post is unread or read by the notification destination user, or a combination of those. The notification data may include other information required for the notification. The format of the notification data is not limited to the example of the at least one embodiment.

The data stored in the data storage unit 100 is not limited to the above-mentioned example. The data storage unit 100 may store any data. For example, the data storage unit 100 may store data (for example, HTML data) required for displaying each of the portal screen SC1, the dashboard screen SC2, the addition screen SC3, the thread screen SC4, the personal mention screen SC5, and the group mention screen SC6. For example, the data storage unit 100 may also store data indicating a specific symbol (for example, “@”) that serves as a criterion for determining whether or not a mention has been made.

### [Posted Data Acquisition Module]

The posted data acquisition module 101 acquires the posted data indicating a post made in the work support system 1. For example, the posted data acquisition module 101 acquires the posted data from the user terminal 20. The posted data indicates a character string input by the user. The posted data may indicate information other than a character string. Examples to be indicated by the posted data may include an emoji, a file, an image, a video, a link, and other information that are designated by the user. In the example of the thread screen SC4 of FIG. 3, the posted data indicates a post input by the user into the input form F40. Instead of directly storing the posted data acquired from the user terminal 20 in the post database DB3, the posted data acquisition module 101 may add information to the posted data, or delete or change a part of the information in the posted data, and then store the posted data in the post database DB3.

For example, when the user makes a new post to a certain thread, the user terminal 20 transmits, to the server 10, the thread ID of the thread to which the new post has been made and the posted data indicating the new post. The posted data acquisition module 101 acquires the thread ID and the posted data from the user terminal 20. The posted data acquisition module 101 stores the thread ID and the posted data that have been acquired from the user terminal 20 in the post database DB3 in association with each other. The posted data acquisition module 101 can acquire the posted data stored in the post database DB3 at any timing. The posted data acquisition module 101 may generate the posted data based on the data acquired from the user terminal 20 instead of acquiring the posted data itself from the user terminal 20.

### [Determination Module]

The determination module 102 determines, based on the posted data, whether or not a group mention with respect to a group has been made. In the at least one embodiment, the determination module 102 determines whether or not a group mention has been made by using a method that is generally the same as that for a personal mention based on the posted data. The personal mention determination method may be a publicly-known method. The group mention determination method may be a determination method that utilizes the publicly-known personal mention determination method.

In the at least one embodiment, a case in which a personal mention is made by inputting a character string indicating a user name after a specific symbol (for example, “@”) is taken as an example. For this reason, a case in which a group mention is made by inputting a character string indicating a group ID after a specific symbol is taken as an example. In addition, in the at least one embodiment, a case in which a character string that does not include a specific symbol corresponds to the group ID is taken as an example, but a character string that includes a specific symbol may correspond to the group ID. In the examples of FIG. 3 to FIG. 5, the character string “@bravo,” which includes not only “bravo” but also “@,” may correspond to the group ID. For the mention, a symbol other than “@” may be used, or an image such as a button may be used instead of inputting a symbol.

For example, the determination module 102 determines, based on the group database DB2, whether or not a specific character string indicating a group ID (for example, “bravo”) has been input after a specific symbol in the post indicated by posted data. When the determination module 102 determines that a specific character string indicating a group ID has not been input after a specific symbol, the determination module 102 does not determine that a group mention has been made. When the determination module 102 determines that a specific character string indicating a group ID has not been input after a specific symbol, the determination module 102 determines that a group mention has been made. When the group ID includes a specific symbol (for example, when group ID is “@bravo”), the determination module 102 may determine whether or not a group mention has been made by determining whether or not the post includes a group ID.

The determination module 102 may perform the determination in accordance with the mention method defined by the work support system 1. For example, when a group mention is made by selecting a specific image or text displayed on the thread screen SC4, the determination module 102 may determine whether or not a group mention has been made by determining whether or not the specific image or text has been selected. The determination module 102 may determine whether or not a group mention has been made by determining whether or not the posted data includes information in a specific format indicating a group mention. The information in a specific format may be data separate from the posted data. For example, the determination module 102 may determine whether or not the data accompanying the posted data indicates a group mention.

### [Group Notification Module]

When it is determined that a group mention has been made, the group notification module 103 issues a group notification N60, which is distinguished from a personal notification N50 of a personal mention with respect to a person, to the group users belonging to the group. The group notification N60 that is distinguished from the personal notifications N50 is a group notification N60 that the user can recognize as a different notification from the personal notifications N50. For example, a group notification N60 displayed in a display area or a screen different from the display area or the screen on which the personal notifications N50 are displayed corresponds to the group notification N60 that is distinguished from the personal notification N50. A group notification N60 that is filtered and displayed separately from the personal notifications N50 corresponds to the group notification N60 that is distinguished from the personal notifications N50.

For example, the group notification module 103 issues a group notification N60 that is distinguished from the personal notifications N50 by displaying the group notification N60 on the group mention screen SC6, which is different from the personal mention screen SC5 on which the personal notifications N50 are displayed. The group notification module 103 generating data for displaying the group notification N60 may correspond to the group notification module 103 issuing the group notification N60. When other means, for example, email, are used instead of displaying on a screen such as the group mention screen SC6, the group notification module 103 issues the group notification N60 by using the other means such that the group notification N60 is distinguished from the personal notifications N50. In the case of email, the subject or the body text indicates that the notification is a group notification N60.

The method by which the group notification module 103 distinguishes between the personal notifications N50 and the group notifications N60 is not limited to the above-mentioned example. For example, the group notification module 103 may distinguish between the personal notifications N50 and the group notifications N60 by notifying personal notifications N50 in a first notification mode and notifying group notifications N60 in a second notification mode. The notification mode is the way in which the notification is made. The notification mode can also be referred to as “notification method.” For example, the notification mode may be the color, size, shape, display position, character string, or a combination thereof, of the notification. The second notification mode is a notification mode different from the first notification mode. When color is used for the notification mode, the group notification module 103 distinguishes between the personal notifications N50 and the group notifications N60 by issuing the personal notifications N50 in a first color and issuing the group notifications N60 in a second color. When another notification mode other than color is used for the notification mode, the group notification module 103 may distinguish between the personal notifications N50 and the group notifications N60 by using the another notification mode.

Further, the group notification module 103 issuing a group notification N60 may mean that the group notification module 103 generates the display data of the group mention screen SC6, or that the group notification module 103 generates the data required for displaying the group notification N60 and stores the generated data in the notification database DB4. In the at least one embodiment, a case in which both of those operations correspond to the group notification module 103 issuing the group notification N60 is taken as an example, but the group notification module 103 performing any one of those operations may correspond to the group notification module 103 issuing the group notification N60. This point also applies to cases in which a group notification is issued by using another method other than the group mention screen SC6.

For example, the group notification module 103 issues the notification ID of the group notification N60 when it is determined that a group mention has been made. The group notification module 103 stores the post ID of the post in which the group mention has been made, the notification ID of the notification, and the notification data of the group notification N60 in the notification database DB4 in association with one another. When a certain group user logs in to the work support system 1, the group notification module 103 issues a group notification N60 to the group user based on the user ID of the group user and the above-mentioned data.

In the at least one embodiment, the group notification module 103 displays, on the user terminal 20 of the group user, the group mention screen SC6 showing group notifications N60 including at least a part of a post in which a group mention has been made. For example, the group notification module 103 displays, on the user terminal 20, the group mention screen SC6 showing the group notifications N60 for the group selected by the group user. As described above, the group notification module 103 may issue the group notification N60 by using another method such as email. When a certain group user instructs that the group mention screen SC6 be displayed, the group notification module 103 displays, on the user terminal 20 of the group user, the group mention screen SC6 showing the group notifications N60 to the group user based on the notification database DB4.

In the example of FIG. 5, the group notification module 103 generates display data of the group mention screen SC6 showing the group notifications N60 to the group “Team Bravo” based on, in the notification database DB4, the notification data on the group “Team Bravo” indicated by the icon I202 selected by the user. The display data may be in any format. The display data may be in any format as long as the format is the format of data required for displaying some kind of screen. For example, when a browser is used on the user terminal 20, the display data may be in the HTML format. When an application dedicated to the work support system 1 is used on the user terminal 20, the display data may be in another format, such as an image format.

In the examples of FIG. 4 and FIG. 5, at least some of the group notifications N60 are also displayed in the display area A22. Thus, the group notification module 103 may issue a group notification by displaying at least some of the group notifications N60 in the display area A22. As another example, it is also possible for a user to recognize that a group notification N60 has been issued based on a badge notification of the icon I202 and a badge notification of the display area A22, and hence the group notification module 103 may make those badge notifications. The badge notifications indicate the number of group notifications N60 unread by the user, and hence the group notification module 103 may identify the number of unread group notifications N60 based on the notification data stored in the notification database DB4, and make a badge notification indicating that number.

### [3-2. Functions Implemented in User Terminal]

For example, the user terminal 20 includes a data storage unit 200, a display control module 201, and an operation reception module 202. The data storage unit 200 is implemented by the storage unit 22. Each of the display control module 201 and the operation reception module 202 is implemented by the control unit 21.

### [Data Storage Unit]

The data storage unit 200 stores data for the work support. For example, the data storage unit 200 stores a browser for displaying various screens of the work support system 1. For example, the data storage unit 200 stores an application dedicated to the work support system 1.

### [Display Control Module]

The display control module 201 displays various screens in the work support system 1 on the display unit 25. For example, the display control module 201 displays, on the display unit 25, each of the portal screen SC1, the dashboard screen SC2, the addition screen SC3, the thread screen SC4, the personal mention screen SC5, and the group mention screen SC6 based on data received from the server 10.

### [Operation Reception Module]

The operation reception module 202 receives various operations in the work support system 1. For example, the operation reception module 202 receives operations performed on each of the portal screen SC1, the dashboard screen SC2, the addition screen SC3, the thread screen SC4, the personal mention screen SC5, and the group mention screen SC6. Data indicating the operation content received by the operation reception module 202 is transmitted to the server 10 as appropriate.

### 4. Processing Executed in Work Support System

An example of processing executed in the work support system 1 is described. In the at least one embodiment, post processing executed when the user makes a post and notification processing executed when the user requests display of notification are described. The post processing and the notification processing are each executed by the control units 11 and 21 executing the programs stored in the storage units 12 and 22, respectively.

### [4-1. Post Processing]

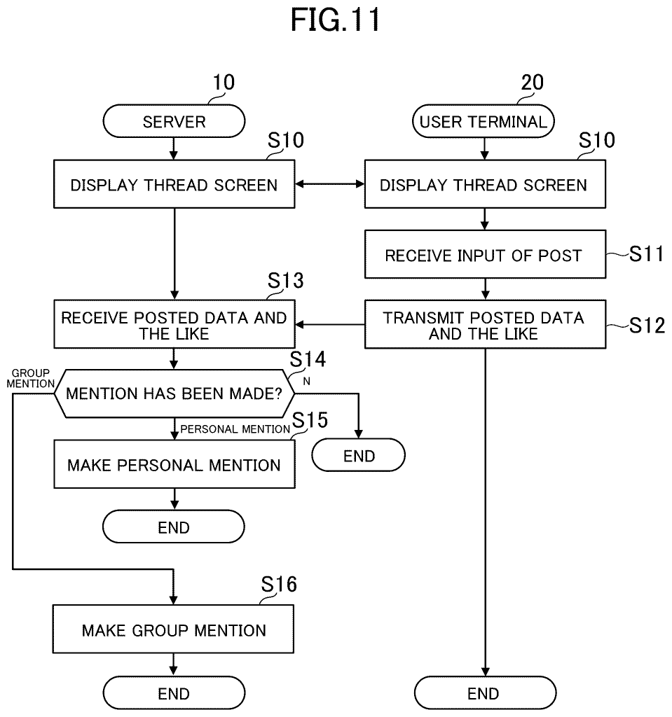

FIG. 11 is a flowchart for illustrating an example of the post processing. In the at least one embodiment, a case in which the user posts to a thread is taken as an example, and hence when the user selects a freely-selected thread, the post processing is executed. The server 10 executes, between the server 10 and the user terminal 20, processing for displaying the thread screen SC4 indicating the thread selected by the user based on the post database DB3 (Step S10). In Step S10, the server 10 generates display data (for example, HTML data) on the thread screen SC4 based on the posted data of existing posts in the thread, and transmits the generated display data to the user terminal 20. The user terminal 20 displays the thread screen SC4 as illustrated in the lower half of FIG. 3 on the display unit 25 based on the display data.

The user terminal 20 receives input of a post into the input form F40 (Step S11). In Step S11, the user can make a post including the character string for a personal mention or for a group mention, or can make a post that does not particularly include such a character string. When the user selects the button B41, the user terminal 20 transmits, to the server 10, the thread ID of the thread being displayed and the posted data indicating the post input by the user (Step S12). The server 10 acquires the thread ID and the posted data from the user terminal 20 (Step S13). In Step S13, the server 10 issues a post ID, and stores the thread ID, the post ID, and the posted data in the post database DB3 in association with one another.

The server 10 determines whether or not a mention of at least one of a personal mention or a group mention has been made based on the user database DB1, the group database DB2, and the posted data (Step S14). In Step S14, the server 10 determines whether or not at least one of a character string for a personal mention or a character string for a group mention is shown in the posted data. When it is determined in Step S14 that none of a personal mention and a group mention has been made (N in Step S14), the post processing ends. In this case, a notification is not issued.

When it is determined in Step S14 that a personal mention has been made (“Personal Mention” in Step S14), the server 10 generates a notification ID, and makes a personal mention by storing the generated notification ID in the notification database DB4 together with the notification data indicating the personal mention (Step S15). Then, the post processing ends. In Step S15, the server 10 generates notification data indicating a personal notification N50 as the notification type, the user ID of the other user who has been personally mentioned as the notification destination, and information on at least a part of the post and the user ID of the user who has posted, for example, as information relating to displaying the notification. The server 10 issues a new notification ID, and stores the issued notification ID in the notification database DB4 together with the notification data.

When it is determined in Step S14 that a group mention has been made (“Group Mention” in Step S14), the server 10 generates a notification ID, and makes a group mention by storing the generated notification ID in the notification database DB4 together with the notification data indicating the group mention (Step S16). Then, the post processing ends. In Step S16, the server 10 generates notification data indicating a group notification N60 as the notification type, the group ID of the group that has been mentioned as the notification destination, and information on at least a part of the post and the user ID of the user who has posted, for example, as information relating to displaying the notification. The server 10 issues a new notification ID, and stores the issued notification ID in the notification database DB4 together with the notification data.

### [4-2. Notification Processing]

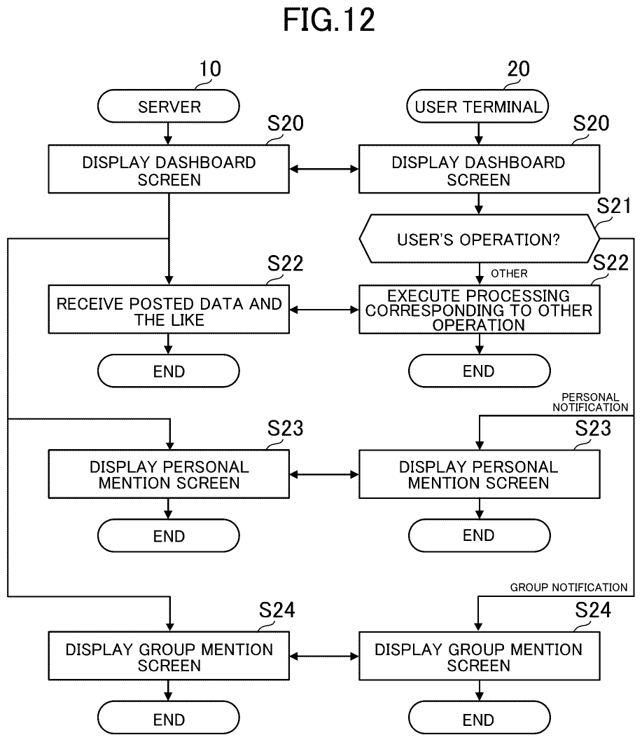

FIG. 12 is a flowchart for illustrating an example of the notification processing. For example, when the user selects the icon I10, the notification processing is executed. The user terminal 20 executes, between the user terminal 20 and the server 10, processing for displaying the dashboard screen SC2 (Step S20). In Step S20, the user terminal 20 transmits to the server 10 a request to display the dashboard screen SC2. When the server 10 receives the display request from the user terminal 20, the server 10 acquires data required for displaying the dashboard screen SC2. For example, of the notification data stored in the notification database DB4, the server 10 acquires the notification data relating to the user ID of the user who has made the display request. The server 10 generates the display data of the dashboard screen SC2 based on the acquired notification data, and transmits the generated display data to the user terminal 20.

The user terminal 20 identifies a user's operation based on a signal detected by the operating unit 24 (Step S21). Here, it is assumed that the user's operation is selection of the icon I200, selection of the icon I202, or some other operation. In Step S21, when the user has performed some other operation (“Other” in Step S21), the user terminal 20 executes, between the user terminal 20 and the server 10, processing corresponding to the other operation (Step S22), and the notification processing ends.

In Step S21, when the user has selected the icon I200 (“Personal Notification” in Step S21), the user terminal 20 executes, between the user terminal 20 and the server 10, processing for displaying the personal mention screen SC5 (Step S23), and the notification processing ends. In Step S23, the user terminal 20 transmits to the server 10 a request to display the personal mention screen SC5. When the server 10 receives the display request from the user terminal 20, the server 10 acquires data required for displaying the personal mention screen SC5. For example, of the notification data stored in the notification database DB4, the server 10 acquires the notification data of the personal notification N50 relating to the user ID of the user who has made the display request. The server 10 generates the display data of the personal mention screen SC5 based on the acquired notification data, and transmits the generated display data to the user terminal 20.

In Step S21, when the user has selected the icon I202 (“Group Notification” in Step S21), the user terminal 20 executes, between the user terminal 20 and the server 10, processing for displaying the group mention screen SC6 (Step S24), and the notification processing ends. In Step S24, the user terminal 20 transmits to the server 10 a request to display the group mention screen SC6. When the server 10 receives the display request from the user terminal 20, the server 10 acquires data required for displaying the group mention screen SC6. For example, of the notification data stored in the notification database DB4, the server 10 acquires the notification data of the group notification N60 relating to the user ID of the user who has made the display request. The server 10 generates the display data of the group mention screen SC6 based on the acquired notification data, and transmits the generated display data to the user terminal 20.

### 5. Summary of at Least One Embodiment

The work support system 1 according to the at least one embodiment acquires posted data, and based on the posted data, determines whether or not a group mention has been made. When it is determined that a group mention has been made, the work support system 1 issues a group notification N60, which is distinguished from a personal notification N50, to the group users belonging to the group to which the group mention has been made. As a result, the user can distinguish between the personal notifications N50 and the group notifications N60, and hence the work support system 1 can increase convenience of the user. For example, when personal notifications N50 and group notifications N60 are not distinguished, unless the user reads the body text of the post, the user does not know whether an action is required to be performed by the user personally or by the group as a whole. In this regard, the work support system 1 distinguishes between the personal notifications N50 and the group notifications N60, and hence even without reading the body text of the post, the user can easily understand whether an action is required to be performed by the user personally or by the group as a whole. When the action is required to be performed by the user personally, the user can determine to respond to the post himself or herself, for example. In a case in which the action is required to be performed by the group as a whole, when someone in the group has responded, the user can determine not to respond himself or herself, for example.

Further, the work support system 1 displays, on the user terminal 20, the group mention screen SC6 showing the group notifications N60 including at least a part of a post in which the group mention has been made. As a result, the user can check the group notifications N60 distinguished from the personal notifications N50 on the group mention screen SC6, and hence the work support system 1 can increase convenience of the user.

### 6. Modification Examples

The present disclosure is not limited to the at least one embodiment described above. The present disclosure can be modified suitably without departing from the spirit of the present disclosure.

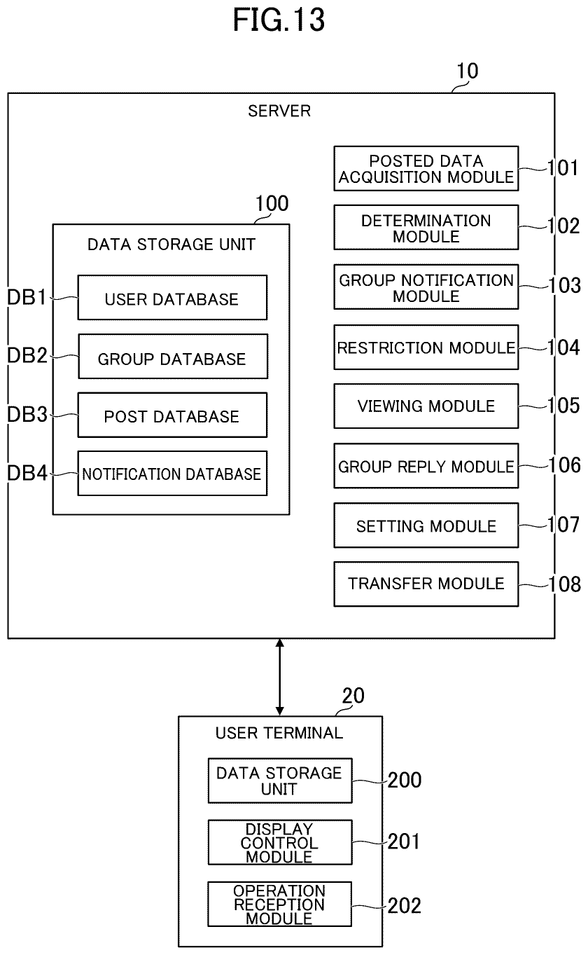

FIG. 13 is a diagram for illustrating an example of functions implemented in the work support system 1 according to modification examples. As illustrated in FIG. 13, in the modification examples described below, a restriction module 104, a viewing module 105, a group reply module 106, a setting module 107, and a transfer module 108 are implemented. Each of the restriction module 104, the viewing module 105, the group reply module 106, the setting module 107, and the transfer module 108 is implemented by the control unit 11.

### 6-1. Modification Example 1

For example, when a reply is made from the group mention screen SC6, the group notification module 103 may display the reply on the group mention screen SC6. In Modification Example 1, a case in which a group user replies from an input form F610 in the display area A61 on the group mention screen SC6 in the lower half of FIG. 5 is taken as an example. For example, the group user inputs the content of a reply to a post displayed in the display area A61 into the input form F610. The post displayed in the display area A61 is a post in which a group mention has been made.

In Modification Example 1, a case in which when a group user replies to a post in which a group mention has been made, a group mention is automatically made in the reply is taken as an example. For example, the group user freely selects and replies to a post from among the posts displayed in the display area A61. In the example of the group mention screen SC6 in the lower half of FIG. 5, the character string “@bravo” is automatically inserted into the reply. The insertion of the character string may be performed by the group notification module 103 or may be performed under control of the user terminal 20 side.

For example, when the group user selects a button B611, the user terminal 20 sends, to the server 10, posted data indicating a reply. The posted data acquisition module 101 acquires the posted data indicating the content of the reply from the user terminal 20. The determination module 102 determines whether or not a group mention has been made in the reply based on the posted data indicating the reply. When it is determined that a group mention has been made in the reply, the group notification module 103 issues a group notification N60 to the group users. This flow is the same as the flow in the at least one embodiment. The group notification module 103 displays the reply on the group mention screen SC6 on which the post that is the source of the reply is displayed.

It is not required that the reply to a post in which a group mention is made automatically include a group mention. Even when a group mention is not automatically made, the group notification module 103 may display the reply on the group mention screen SC6. In this case, the group notification module 103 refers to the user ID of the user who has made the reply indicated by the posted data, and determines, based on the group database DB2, whether or not the user belongs to the group to be displayed on the group mention screen SC6. When it is determined that the reply is from a user belonging to the group, the group notification module 103 may display the reply on the group mention screen SC6.

The work support system 1 according to Modification Example 1 displays, when a reply is made from the group mention screen SC6, the reply on the group mention screen SC6. This enables the group user to check replies to posts in which a group mention has been made on the group mention screen SC6. For example, the group user can more easily grasp how the user themselves or another group user has replied and responded to a post requiring some sort of action from the group, and hence the work support system 1 can further increase convenience of the group user.

### 6-2. Modification Example 2

For example, the group notification module 103 may display, on the user terminal 20, a group mention screen SC6 in which a poster who has input the post in which the group mention is made is associated with the group notification N60 of the post. As used herein, “poster” refers to a user who has input a post in which a group mention has been made. The poster may be a group user or may be an external user. The association between the poster and the group notification N60 means that it is possible to identify who has input the post notified by the group notification N60.

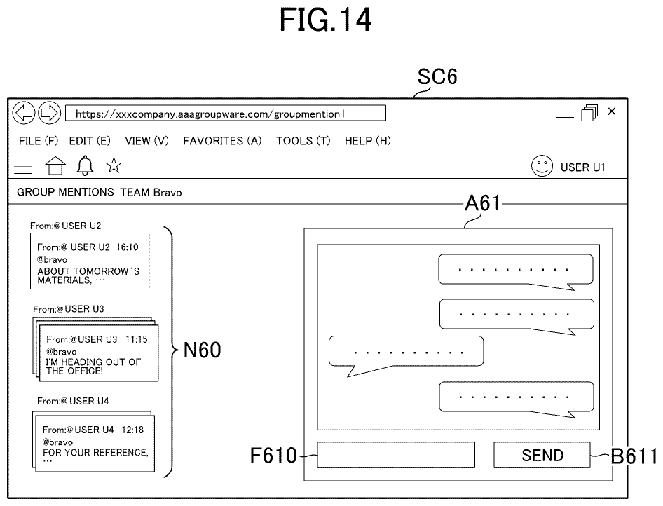

FIG. 14 is a view for illustrating an example of the group mention screen SC6 in Modification Example 2. For example, the group notification module 103 displays, on the group mention screen SC6, for each poster, the group notifications N60 of the posts that have been input by the poster including a group mention. The group notification N60 filters the plurality of group notifications N60 by poster, and then displays, on the group mention screen SC6, for each poster, the posts in which the poster has made a group mention. The group notification module 103 may identify the posters based on the notification database DB4.

In the example of FIG. 14, the group notification module 103 displays, on the group mention screen SC6 of the group user U1, the group notifications N60 of the posts in which each of the other group users U2 to U4, who belong to the same group as that of the group user U1, has made a group mention. For example, the group notification module 103 arranges the group notifications N60 of the posts in which each of the group users U2 to U4 has made a group mention under the user name. In the example of FIG. 14, arranging the group notifications N60 under the user name corresponds to associating the poster with the group notifications N60. As illustrated in FIG. 14, for a poster (in the example of FIG. 14, users U3 and U4) for which a plurality of group notifications N60 exist, the group notifications N60 may overlap.

The method by which the group notification module 103 associates the poster with the group notifications N60 is not limited to the example of FIG. 14. For example, the group notification module 103 may display the poster and the group notifications N60 in association with each other by arranging the group notifications N60 above, to the left, or to the right of the user name of the poster. The group notification module 103 may display, when the group user has selected a poster, the poster and the group notifications N60 in association with each other by filtering the group notifications N60 of the posts made by the poster and displaying the filtered group notifications N60 on the group mention screen SC6.

The work support system 1 according to Modification Example 2 displays, on the user terminal 20, a group mention screen SC6 in which a poster and a group notification N60 are associated with each other. This enables the user to easily grasp who has posted the post indicated by the group notification N60, and hence the work support system 1 can further increase convenience of the user.

### 6-3. Modification Example 3

For example, when a group user belongs to a plurality of groups, the group notification module 103 may display, on the user terminal 20, a group mention screen SC6 of a group selected by the group user from among the plurality of groups. In Modification Example 3, an icon I202 for each of a plurality of groups is displayed on the dashboard screen SC2 of a group user who belongs to the plurality of groups. It is assumed that the display data on the dashboard screen SC2 includes the group ID of each of the plurality of groups.

For example, when the server 10 has received a request to display the dashboard screen SC2 from the user terminal 20 of the group user, the server 10 identifies the groups to which the group user belongs based on the group database DB2. When the group user belongs to a plurality of groups, the server 10 displays a dashboard screen SC2 showing an icon I202 for each of the plurality of groups on the user terminal 20. The group user can select any of the icons I202. It is assumed that the image data of the icons I202 is stored in the group database DB2.

For example, the server 10 acquires the group ID of the group indicated by the icon I202 selected by the user from the user terminal 20. The group notification module 103 in Modification Example 3 identifies the group notifications N60 of the group indicated by the group ID based on the notification database DB4. The group notification module 103 displays a group mention screen SC6 showing the identified group notifications N60 on the user terminal 20. Modification Example 3 differs from the at least one embodiment in that the group notifications N60 for the group selected by the group user from among a plurality of groups are displayed on the group mention screen SC6, but the processing for displaying the group mention screen SC6 may be the same as that in the at least one embodiment. The group notification module 103 may identify the group notifications N60 of the group to be displayed on the group mention screen SC6 based on the notification data stored in the notification database DB4, and display the identified group notifications N60 on the group mention screen SC6.

The work support system 1 according to Modification Example 3 displays, on the user terminal 20, a group mention screen SC6 of a group selected by the group user from among a plurality of groups when the group user belongs to the plurality of groups. This enables a user who belongs to a plurality of groups to check the group notifications N60 of any group, and hence the work support system 1 can further increase convenience of the user.

### 6-4. Modification Example 4

For example, the group notification module 103 may issue a group notification N60 to the group users when an external user who does not belong to the group makes a group mention. That is, in the at least one embodiment, a case in which a group user belonging to a certain group makes a group mention with respect to the group has been taken as an example, but in Modification Example 4, an external user makes a group mention with respect to the group. In the example of the group “Team Bravo” described in the at least one embodiment, the external user makes a post that includes the character string “@bravo.”

The posted data acquisition module 101 in Modification Example 4 acquires the posted data of the post input by the external user. The determination module 102 determines whether or not a group mention has been made in the post input by the external user based on the posted data. When it is determined that a group mention has been made in the post input by the external user, the group notification module 103 issues a group notification N60 to the group users. Modification Example 4 differs from the at least one embodiment in that the post indicated by the posted data is input by an external user, but this flow is the same as the flow in the at least one embodiment.

The work support system 1 according to Modification Example 4 issues a group notification N60 to the group users when an external user makes a group mention. This enables the external user to make a group mention with respect to a group to which the external user does not belong, and hence the work support system 1 can further increase convenience of the external user and the group users. For example, when an external user requests a group to which the external user does not belong to perform some sort of work, the external user can make a group mention so that the group users of the group may notice the post more easily. The group users can notice requests from external users more easily, and hence requests from external users to the group are less likely to be overlooked.

### 6-5. Modification Example 5

For example, in Modification Example 4, the group notification module 103 may distinguish between a group notification N60 of a group mention made by another group user belonging to the group and a group notification N60 of a group mention made by an external user. The group notification N60 that is issued when the group mention is made by another group user is hereinafter referred to as “group user notification N60,” and the group notification N60 that is issued when the group mention is made by an external user is hereinafter referred to as “external user notification N60.” Whether a certain group notification N60 is a group user notification N60 or an external user notification N60 may be indicated by the type of the notification, or may be determined based on the user who has made the post serving as the origin of the notification. The group notification module 103 may determine whether or not the poster who has made the group mention of the certain group is a group user of the group or an external user of the group based on the group database DB2.

The group notification module 103 may use any method to distinguish between the group user notifications N60 and the external user notifications N60. For example, the group notification module 103 distinguishes between the group user notifications N60 and the external user notifications N60 by issuing the group user notifications N60 in a third notification mode and issuing the external user notifications N60 in a fourth notification mode. The fourth notification mode is a notification mode different from the third notification mode. The meaning of the notification mode is as described in the at least one embodiment. When color is used for the notification mode, the group notification module 103 distinguishes between the group user notifications r N60 external user notifications N60 by issuing the group user notifications N60 in a third color and issuing the external user notifications N60 in a fourth color. When another notification mode other than color is used for the notification mode, the group notification module 103 may distinguish between the group user notifications N60 and the external user notifications N60 by using the another notification mode.

The group notification module 103 may distinguish between the group user notifications N60 and the external user notifications N60 by using another method other than the notification mode. For example, the group notification module 103 may distinguish between the group user notifications N60 and the external user notifications N60 by filtering group notifications N60 by one type of notification selected by the group user out of the group user notifications N60 and the external user notifications N60, and displaying the filtered group notifications N60 on the group mention screen SC6. The group notification module 103 may distinguish between the group user notifications N60 and the external user notifications N60 by displaying each of those types of notifications on separate group mention screens SC6.

The work support system 1 according to Modification Example 5 distinguishes between the group user notifications N60 and the external user notifications N60. This enables a group user to more easily grasp whether a group notification N60 is a group user notification N60 or an external user notification N60, and hence the work support system 1 can further increase convenience of external users and group users.

### 6-6. Modification Example 6

For example, in Modification Example 4 or Modification Example 5, external users may be prevented from viewing a post made in the group. The post made in the group may be a post in which a group user of the group has made a group mention with respect to the group, or may be a post made in a place (for example, a thread) created exclusively for the group. In Modification Example 6, as a general rule, posts made within the group are not viewable by external users, but when an external user is personally mentioned, the external user may view the post as an exception.

The work support system 1 according to Modification Example 6 includes the restriction module 104. The restriction module 104 restricts external users from viewing posts made in the group. As used herein, “restrict from viewing” means “prohibit from viewing.” The restriction module 104 restricts such that the content of posts made in the group is not transmitted to the user terminal 20 of external users. For example, when a certain external user requests the display of a given post, the restriction module 104 transmits the content of posts made in a group to which the external user belongs to the user terminal 20 of the external user, but does not transmit the content of posts made in groups to which the external user does not belong.

The restriction module 104 may identify the groups from which the external user is permitted to view posts by identifying the groups to which the external user belongs based on the group database DB2. The restriction module 104 may identify the group that each post belongs to based on the post database DB3. Information indicating which group each post belongs to may be included in the posted data, or may be data separate from the posted data. The restriction module 104 distinguishes between the posts that are permitted to be viewed by external users and the posts that are not permitted to be viewed by external users based on the identification results. The restriction module 104 restricts the data of posts that are not permitted to be viewed by external users from being transmitted to the user terminal 20 of external users, and permits the data of posts that are permitted to be viewed by external users to be transmitted to the user terminal 20 of the external users.

The work support system 1 according to Modification Example 6 restricts external users from viewing posts made in the group. This enables a group user to communicate with other group users in the same group without the communication being known by external users, and hence the work support system 1 can further increase convenience of the group user. For example, a group user may determine how to respond to an inquiry from an external user while consulting with other group users in the same group. It may be desirable that those consultations do not catch the attention of the external user. In such a case, the work support system 1 can prevent external users from viewing posts within the group.

### 6-7. Modification Example 7

For example, in contrast to Modification Example 6, posts made in a group may be viewable by an external user. The work support system 1 according to Modification Example 7 includes the viewing module 105. The viewing module 105 permits an external user to view posts made in the group. The viewing module 105 transmits the content of posts made in the group to the user terminal 20 of the external user. For example, when a certain external user requests the display of a given post, the viewing module 105 transmits the content of posts made in the groups to which the external user belongs to the user terminal 20 of the external user, and also transmits the content of posts made in groups to which the external user does not belong. The viewing module 105 may execute processing for permitting an external user to view a post based on the post database DB3. In Modification Example 7, the processing of the restriction module 104 as in Modification Example 6 is not executed.

The work support system 1 according to Modification Example 7 permits an external user to view the posts made in a group. As a result, the external user can know the content of the communication between the group users of a group to which the external user does not belong, and hence the work support system 1 can further increase convenience of the external user. For example, the external user can know whether or not a request made to a certain group is being considered by the group users (know whether or not a request by the external user is being overlooked).

### 6-8. Modification Example 8

For example, in any of Modification Example 4 to Modification Example 7, when a group user has replied to a post from an external user, the reply may be treated as a reply in the name of the group. As used herein, “reply in the name of the group” means that the poster becomes the group name instead of the name of the individual group user who has actually input the reply. On the user terminal 20 of the external user, the poster who has posted the reply becomes the group name. The user name of the individual group user who has actually input the reply may be displayed together with the group name.

The work support system 1 according to Modification Example 8 includes the group reply module 106. When a group user replies to a post by an external user, the group reply module 106 issues a reply to the external user in the name of the group. For example, the group reply module 106 sets the group name instead of the group user for the name of the party that has sent the reply (reply poster). The group reply module 106 stores posted data indicating that the party that has sent the reply is the group (for example, posted data in which the poster is a group ID or a group name) in the post database DB3. When a reply based on such posted data is displayed, the party that has sent the reply is displayed on, for example, the thread screen SC4 or the personal mention screen SC5 of the external user, as a group name instead of the name of the individual group user.

The work support system 1 according to Modification Example 8 sends, when a group user replies to a post by an external user, a reply in the name of the group to the external user. This enables the external user to easily grasp which group the reply is from, and hence the work support system 1 can further increase convenience of the external user.

### 6-9. Modification Example 9

For example, an officer in an organization has various types of work to perform, and hence other people supporting the officer may perform some kind of action on behalf of the officer. Thus, in Modification Example 9, a case in which a personal mention with respect to a specific person is treated as a group mention is taken as an example. The specific person may be any user and is not limited to an officer. For example, the specific person may be a user who receives inquiries, a user on extended leave, a user on a leave of absence, or another user.

In Modification Example 9, a case in which the president of a company that has a contract to use the work support system 1 corresponds to the specific person is taken as an example. It is assumed that data that can identify the specific person is stored in the data storage unit 100. For example, the user ID of a certain user and specific-person data indicating whether or not the user is a specific person may be associated in the user database DB1. In Modification Example 9, it is assumed that specific-person data indicating that the user is a specific person is associated with the user ID of the user who is the company president.

The determination module 102 in Modification Example 9 determines whether or not a personal mention has been made based on the posted data. The method for performing the determination is as described in the at least one embodiment. The determination module 102 determines, when a personal mention with respect to a specific person has been made, that a group mention of a specific-person group, which is a group associated with the specific person, has been made. The specific-person group is a group which supports the work of the specific person. It is assumed that data such as the group ID of the specific-person group is stored in the group database DB2. Thus, the group database DB2 shows who the group users of the specific-person group are. For example, when the specific user is a company president, a secretary belonging to the president's office is registered as a group user. The company president himself or herself also, who is the specific person, may be registered as a group user.

For example, in a case in which the user name of the company president is “Saibo Taro,” when a certain poster makes a post including the character string “@Saibo Taro,” because the character string after “@” is the name of a person, not a group name, the mention in this post would normally be treated as a personal mention. However, “Saibo Taro” is registered as the specific user, and hence the determination module 102 determines that a group mention of the specific group has been made. For example, the determination module 102 determines that a group mention of a specific group, that is, the president's office which supports the work of “Saibo Taro,” has been made.

The group notification module 103 in Modification Example 9 issues a group notification N60 to the group users belonging to the specific-person group when it is determined that a group mention of the specific-person group has been made. The group notification module 103 identifies the group users of the specific-person group based on the group database DB2. The group notification module 103 generates notification data so that the group users are notified, and stores the generated notification data in the notification database DB4. This processing is different from the at least one embodiment in that the group notification N60 is issued to the group users of a specific-person group, but the notification method for the group notification N60 itself is as described in the at least one embodiment.

The work support system 1 according to Modification Example 9 determines that a group mention of a specific-person group has been made when a personal mention with respect to a specific person has been made. When the work support system 1 determines that a group mention of the specific-person group has been made, the work support system 1 issues a group notification N60 to the group users belonging to the specific-person group. As a result, even when a specific person fails to notice a post in which he or she is mentioned, other people can notice the post. For example, when the specific person is a company president, there is a possibility that a busy company president may overlook a personal notification N50. In this regard, because the group notification N60 is made to group users belonging to a specific-person group such as the president's office, the group users can notice posts addressed to the company president.

### 6-10. Modification Example 10

For example, in Modification Example 9, when a certain user receives a promotion and becomes busier or goes on a long-term business trip, it may be difficult for the user to notice personal notifications, and hence it may be better to treat the user as a specific person. Thus, a user may be treated as a specific person based on a predetermined condition. The predetermined condition is a condition which serves as a criterion for determining whether or not a user is to be treated as a specific person. The predetermined condition may be any condition that can be used to perform that determination based on some sort of data on the user. For example, the predetermined condition may be the work position, schedule, years of service, department, or another condition of the user.

The work support system 1 according to Modification Example 10 includes the setting module 107. The setting module 107 sets a user who satisfies a predetermined condition as a specific person. For example, the setting module 107 determines whether or not a predetermined condition is satisfied based on data on the user stored in the user database DB1. The setting module 107 does not set the user as a specific person when it is determined that the predetermined condition is not satisfied, and sets the user as a specific person when it is determined that the predetermined condition is satisfied. The setting module 107 updates the specific-person data associated with the user ID of the user to indicate that the specific-person data relates to a specific person.

For example, when the predetermined condition is the user becoming a predetermined work position, the setting module 107 determines whether or not the predetermined condition is satisfied by determining whether or not the work position of the user stored in the user database DB1 has become the predetermined work position. The setting module 107 sets the user as a specific person when it is determined that the work position of the user has become a predetermined work position. When the predetermined condition is the user being on a business trip, the setting module 107 determines whether or not the predetermined condition is satisfied by acquiring the schedule of the user from the user database DB1 or another database and determining whether or not the user is planning to go on a business trip. The setting module 107 sets the user as a specific person when it is determined that the user is planning to go on a business trip.

In addition, the group users of the specific group to which a group notification N60 is made when a certain user is set as a specific person may be manually designated by the user or another user, or the people in the same department may be automatically registered by the setting module 107. The group ID and the group name of the specific group may be automatically generated based on a format prepared by the work support system 1, or may be manually designated by the user set as a specific person or another user. When a certain user is set as a specific person, the setting module 107 stores the group ID, the group name, and the group users of the specific group of the user set as a specific person in the group database DB2.

The work support system 1 according to Modification Example 10 sets a user who satisfies a predetermined condition as a specific person. This enables the work support system 1 to effectively support the work of the user satisfying the predetermined condition. For example, in a case in which a certain user receives a promotion and becomes busier or goes on a long-term business trip, when it is difficult for the user to notice personal notifications, the work support system 1 can set the user as a specific person and issue group notifications N60 to allow the group users of the specific group to notice posts.

### 6-11. Modification Example 11

For example, even when a group mention is made with respect to a certain group in a post making an inquiry to the group, there may be cases in which it is better for another group to handle the inquiry. Thus, when such a post is to be transferred, the post may be transferred by replacing the original group mention with a group mention of the another group. In Modification Example 11, a case in which a post making an inquiry to the group “Development Department” is transferred by replacing the group mention with respect to the group “Development Department” with a group mention with respect to the group “Intellectual Property Department” is taken as an example. It is assumed that the data on the group ID, the group name, and the group users of those groups is stored in the group database DB2.

The work support system 1 according to Modification Example 11 includes the transfer module 108. The transfer module 108 replaces, when a group user is to transfer a post to another group, a group mention of a certain group with a group mention of another group, and transfers the post. As used herein, “replaces a group mention” means changing the data or the data portion indicating a group mention of a certain group to data or a data portion indicating a group mention of another group. For example, the transfer module 108 replaces the group mention with respect to a certain group with a group mention with respect to another group, and transfers the post. The transfer module 108 transfers the post by storing the posted data indicating the post to be transferred in the post database DB3. When the post has been transferred, based on the same flow as in the at least one embodiment, it is determined that a group mention of another group has been made, and a group notification N60 is issued to the group users of the another group.

For example, there may be a case in which a post with respect to the group “Development Department” includes the character string “@development” indicating a group mention with respect to the group “Development Department.” When the content of the post relates to intellectual property, a group user in the group “Development Department” designates the group “Intellectual Property Department” and performs a transfer operation. The transfer module 108 replaces the relevant character string portion with the character string “@ip” indicating a group mention with respect to the group “Intellectual Property Department” designated by the group user, and then performs the transfer. As a result, a group notification N60 is issued to the group users of the group “Intellectual Property Department.”

The group replacing the original group may be designated by a group user each time a transfer is made, or may be determined in advance. The transfer module 108 may perform the transfer by replacing the original group mention with a group mention of another group determined in advance. In this case, it is assumed that data indicating the another group determined in advance is stored in the data storage unit 100 in advance. The transfer module 108 may identify which group is to replace the original group based on that data.

In the work support system 1 according to Modification Example 11, when a group user of a certain group transfers a post to another group, the group mention of the group is replaced with a group mention of another group, and the post is transferred. This eliminates the necessity for group users to perform a post to another group from scratch, and hence the work support system 1 can reduce the operational burden on group users when transferring.

### 6-12. Other Modification Examples

For example, two or more of Modification Examples 1 to 11 may be combined.

For example, the functions described as being implemented by the server 10 may be implemented by the user terminal 20. In this case, it suffices that the functions are implemented by a browser script or an application installed on the user terminal 20. For example, the respective functions may be distributed to a plurality of computers, or may be implemented by a single computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A work support system, comprising at least one processor configured to:
acquire posted data indicating a post in a work support system;
determine, based on the posted data, whether a group mention with respect to a group has been made; and
issue, when it is determined that the group mention has been made, a group notification to a group user belonging to the group, the group notification being distinguished from a personal notification of a personal mention with respect to a person.

2. The work support system according to claim 1, wherein the at least one processor is configured to display, on a user terminal of the group user, a group mention screen showing the group notification including at least a part of the post in which the group mention has been made.

3. The work support system according to claim 2, wherein the at least one processor is configured to display, when a reply is made from the group mention screen, the reply on the group mention screen.

4. The work support system according to claim 2, wherein the at least one processor is configured to display, on the user terminal, the group mention screen in which a poster who has input the post in which the group mention has been made is associated with the group notification of the post.

5. The work support system according to claim 2, wherein the at least one processor is configured to display, on the user terminal, when the group user belongs to a plurality of groups, the group mention screen of a group selected by the group user from among the plurality of groups.

6. The work support system according to claim 1, wherein the at least one processor is configured to issue the group notification to the group user when an external user who does not belong to the group has made the group mention.

7. The work support system according to claim 6, wherein the at least one processor is configured to distinguish between the group notification of the group mention made by another group user belonging to the group and the group notification of the group mention made by the external user.

8. The work support system according to claim 6, wherein the at least one processor is configured to restrict the external user from viewing the post made in the group.

9. The work support system according to claim 6, wherein the at least one processor is configured to permit the external user to view the post made in the group.

10. The work support system according to claim 6, wherein the at least one processor is configured to issue, when the group user has replied to the post by the external user, a reply to the external user in the name of the group.

11. The work support system according to claim 1, wherein the at least one processor is configured to:
determine, when the personal mention with respect to a specific person has been made, that the group mention of a specific-person group which is the group associated with the specific person has been made; and
issue the group notification to the group user belonging to the specific-person group when it is determined that the group mention of the specific-person group has been made.

12. The work support system according to claim 11, wherein the at least one processor is configured to set a user satisfying a predetermined condition as the specific person.

13. The work support system according to claim 1, wherein the at least one processor is configured to replace, when the group user is to transfer the post to another group, the group mention of the group with the group mention of the another group, and transfer the post.

14. A work support method, comprising:
acquiring posted data indicating a post in a work support system;
determining, based on the posted data, whether a group mention with respect to a group has been made; and
issuing, when it is determined that the group mention has been made, a group notification to a group user belonging to the group, the group notification being distinguished from a personal notification of a personal mention with respect to a person.

15. A non-transitory information storage medium having stored thereon a program for causing a computer to:
acquire posted data indicating a post in a work support system;
determine, based on the posted data, whether a group mention with respect to a group has been made; and
issue, when it is determined that the group mention has been made, a group notification to a group user belonging to the group, the group notification being distinguished from a personal notification of a personal mention with respect to a person.
